(19) United States
(12) Patent Application Publication
(10) Pub. No.: US 2012/0044354 A1
(43) Pub. Date: Feb. 23, 2012

(54) VERSATILE DUAL MODE WIRELESS CAMERA HOTSPOT DEVICE

(76) Inventors: Fred Cheng, Los Altos Hills, CA (US); Herman Yau, Palo Alto, CA (US)

(21) Appl. No.: 12/860,910

(22) Filed: Aug. 22, 2010

(51) Int. Cl. H04N 7/18; H04W 84/02; H04N 5/225

(52) U.S. Cl. 348/159; 348/207.1; 370/338; 348/E07.085; 348/E05.024

(57) ABSTRACT

A versatile dual mode wireless camera hotspot and method. The method comprises capturing data comprising at least one of video and audio from a camera. The camera has a transmitter and receiver integrated with the camera. The camera further provides a wireless access point to allow access to a network.

### FIELD OF THE INVENTION

The present disclosure is directed to a camera for the capture of surveillance video data. The camera operates in at least two modes, or a first mode that interrogates to available devices to link to those devices, and a second mode for the delivery of the surveillance data to a second device for display on the second device. More particularly, the present disclosure is directed to a surveillance camera that forms a wireless access point.

### BACKGROUND OF THE RELATED ART

Prior art surveillance applications are known in the art. The surveillance applications include a digital video camera connected to a digital video recorder. Generally, the digital video recorder has a memory and is operatively connected to the digital video camera close by. When motion is detected inside the predetermined area, video capture can be activated. Digital or analog video data can then be recorded on to the local recorder. Generally, a user must configure the video camera to a wireless network, which may be time consuming and may require the user to purchase additional computing devices to route and record the data.

A configuration of the instant applicant is shown in FIG. 1. The applicant's prior art configuration has a wireless camera A, and a wireless camera B. The cameras A and B communicate to a wireless router C, which is connected to the internet D. A number of computing devices E, F, G, and H are also provided.

The prior art does not allow a user to capture video and audio with a video camera and have the video camera itself continuously interrogate other devices to link to other devices. The prior art also does not allow a user to provide a convenient wireless access point to allow access to a network. Generally, a user must link and configure each camera to a network one at a time, which can be time consuming. Further, if there is not a wireless access point, time and expenses must be made to furnish a wireless access point in order to link one or more cameras to a network, which can be costly.

### SUMMARY OF THE INVENTION

According to a first aspect of the present disclosure, there is provided a method. The method comprises capturing data comprising at least one of video and audio from a camera. The camera has a transmitter and receiver integrated with the camera. The camera further provides a wireless access point to allow access to a network.

In yet another aspect of the present disclosure there is provided a wireless camera comprising an image capture device for capturing video images. The wireless camera also has a transmitter, a receiver and a circuit that provides a wireless access point to allow access to a wireless network by at least a second device.

In another embodiment of the present disclosure, there is provided a surveillance camera. The camera has an image capture device for capturing digital video images, and a microphone for capturing audio data. The camera also has an RF unit comprising a transmitter and a receiver that is connected to the image capture device and microphone. The RF unit communicates with a router for directing the captured video images and audio data to (i) a portable device and to (ii) a computing device associated with a remote destination via at least one communication path of a plurality of communication paths. The surveillance camera further provides a wireless access point to allow access to a network by at least one of (i) a second camera, (ii) a computing device, and (iii) a mobile communication device.

According to yet another embodiment of the present disclosure there is provided a method. The method includes capturing data comprising digital video images and audio data and routing the captured video images and audio data to (i) a router at a first mobile location and (ii) a second computing device at a second remote destination. The data is captured by a device that further provides a wireless access point to allow access to a network.

According to yet another embodiment of the present disclosure there is provided a device comprising a receiver for receiving data associated with captured video images and audio data. The device also has a transmitter to transmit data to a computing device associated with a remote destination via at least one communication path of a plurality of communication paths. The transmitter and the receiver are integrated into a surveillance camera. The surveillance camera further provides a wireless access point to allow a second device access to a wireless network.

According to yet a further embodiment of the present disclosure there is provided a camera that captures images and that also serves as a wireless access point to connect at least a second device to the internet to reduce costs.

According to yet a further embodiment of the present disclosure there is provided a camera that can be switched between at least two modes.

According to yet a further embodiment of the present disclosure there is provided at least two cameras where at least two cameras captures images and audio and at least one serves as a wireless access point.

### BRIEF DESCRIPTION OF THE FIGURES

The foregoing and other objects, features and advantages of the invention will be apparent from the following more particular description of preferred embodiments of the invention, as illustrated in the accompanying drawings in which like reference characters refer to the same parts throughout different views. The drawings are not meant to limit the invention to particular mechanisms for carrying out the invention in practice, but rather, the drawings are illustrative of certain ways of performing the invention. Others will be readily apparent to those skilled in the art.

FIG. 1 shows a system diagram of applicant's prior system with a number of wireless cameras being connected to a Wi-Fi router for access to the internet;

FIG. 2 shows a schematic of the present dual mode wireless digital camera operating in a network mode;

FIG. 3 shows a schematic of the present dual mode wireless digital camera operating in a direct mode;

FIG. 4 shows a schematic of the present dual mode wireless digital camera operating in a direct mode and network mode;

FIG. 5 shows a schematic of the present wireless digital camera operating as a wireless access point and functioning as a mobile hotspot; and

FIG. 6 shows a number of method steps for configuring the digital camera as a mobile hotspot and also for configuring the camera with a computing device.

### DETAILED DESCRIPTION OF THE PREFERRED EMBODIMENTS

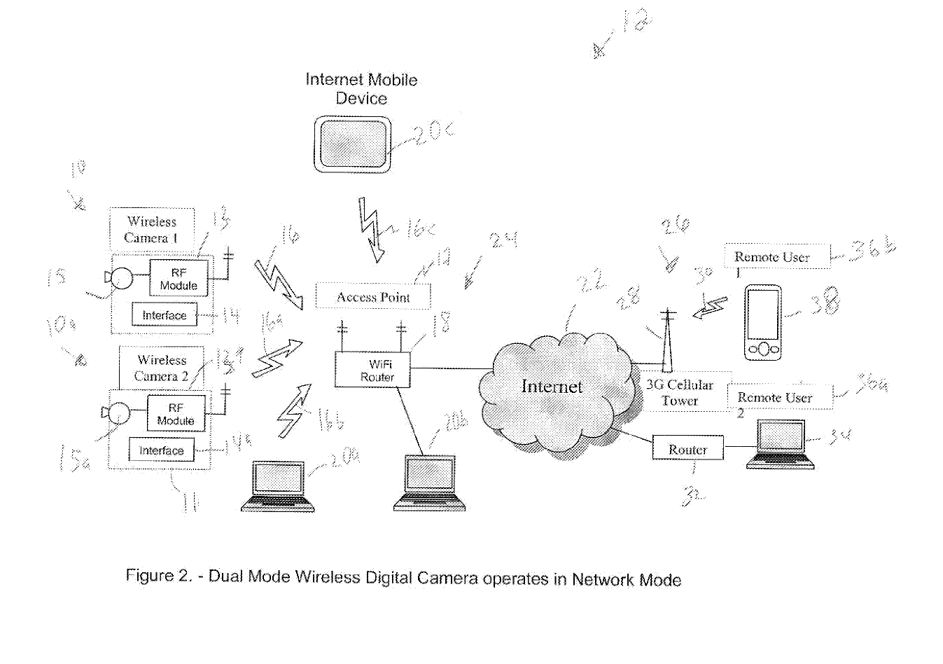

The present disclosure preferably is directed to a surveillance video camera 10. The camera 10 is for capturing of surveillance data (video and audio) in a remote and continuous manner. Preferably, the camera 10 operates in two modes or a first network mode and a second direct mode as will be discussed herein. The camera 10 includes a wireless access point integrated within and formed by the camera 10. In the modes shown in FIG. 2-6, the camera 10 can transmit data to a mobile device and be configured by the mobile device. Alternatively, the camera 10 may form a mobile hotspot whereas other second devices may connect to the internet 22 via the camera 10. This provides with a very advantageous configuration whereby a mobile communication device located close by can receive a feed of the camera 10 and also the camera 10 together with other surveillance cameras can be much more easier to install and can be installed cheaper than the prior art.

Turning now to FIG. 2, there is shown a system 12 wherein the camera 10 of the present disclosure is illustrated. The camera 10 preferably includes an RF module 13 with an interface 14. Preferably, the RF module 13 includes a transmitter/receiver or transceiver to send and receive control signals 16. Preferably, the control signals 16 are digital control signals 16; however alternatively, the control signals 16 may also be analog signals.

The interface 14 preferably may include a controller (not shown), a memory (not shown) and a bus (not shown) that preferably couples an image sensor 15 from the camera 10 to the controller, and memory. The controller preferably includes a digital signal processor that preferably outputs control signals to one or more components of the camera 10. The memory may be sufficient to record video and audio data for a predetermined period of time.

Camera 10 may have a video resolution of about 640×480, 320×240, and 160×120, the frame rate can be up to 30 fps with the video encoding being a MPEG4 simple profile. The camera 10 may also has image settings that include brightness, sharpness, contrast, white balance and a built-in microphone. Cameral 10 may also have a 5V DC external power adapter with an operating temperature of preferably 0° C.˜40° C. (32° F.˜104° F.) and an operating humidity of 20%˜80% (non-condensing of the lens).

The system 12 preferably includes a Wi-Fi router 18 that wirelessly receives signals from the camera 10 and RF module 13. The Wi-Fi router 18 preferably then transfers the data received by the RF module 13 corresponding to the video and audio data to one or more destinations. In one aspect, the first destination 24 may be a computer 20a, 20b or 20c that is located closely adjacent to the camera 10. The computer 20a, 20b and 20c may be a laptop computer 20a and 20b, a desktop computer (not shown), a net book computer or a tablet computer 20c as shown. At least one computer 20a preferably has requirements of a processor (not shown) of 1.4 GHz or above that can be operable with an operating system of MICROSOFT® WINDOWS® 7, MICROSOFT® WINDOWS® VISTA®, and MICROSOFT®WINDOWS® XP® operable with a USB 1.1/2.0 port and having about 256 MB RAM and 100 MB hard disk space. Various computer configurations are possible and within the scope of the present disclosure.

In another aspect, the second destination 26 comprises a base station 28 that may wirelessly transmit data to a remote user 36a or second user 36b. The second destination 26 may further comprise a router 32 that is connected to a computer 34. In this aspect, a user 36a may view video and listen to audio data at the second destination 26 from the wireless camera 10 at the first destination 24. Also a user 36b may have a mobile communication device 38 that receives wireless signals 30 from a base station 28 that is connected to the internet 22 to view video and listen to audio data at the second destination 26.

The wireless digital surveillance camera 10 may be operable with multiple other wireless digital surveillance cameras 10a also having an RF module 13a, image capture unit 15a, and an interface 14a disposed in a housing 11. The wireless digital surveillance camera 10 and camera 10a preferably combines the access point and camera into one integral unit whereas the camera 10 and 10a may capture video images and optionally audio images and also transmit the video and audio data in a specific protocol to at least two or more destinations 24 and 26. Therefore a third user 36c operating the mobile device 20c or a first user 36a operating a computer device 34, or a second user 36b operating a mobile device 38 at the second destination 26 has the option to connect directly to the desired camera 10 and 10a.

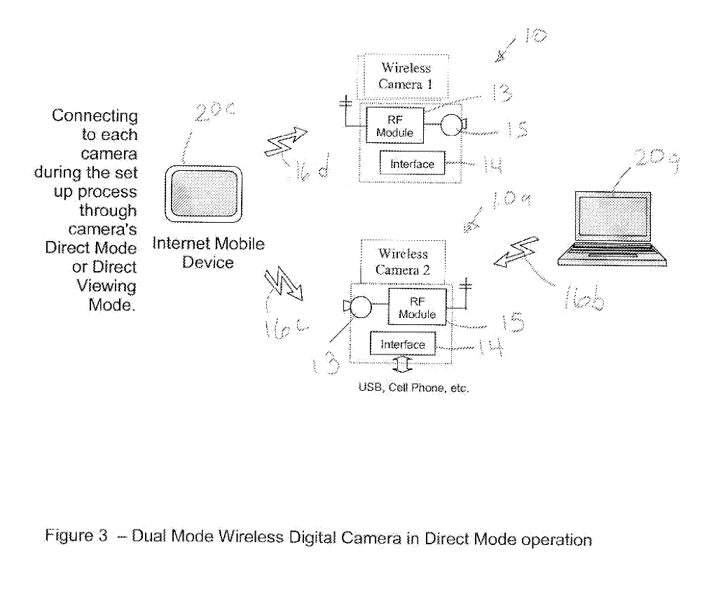

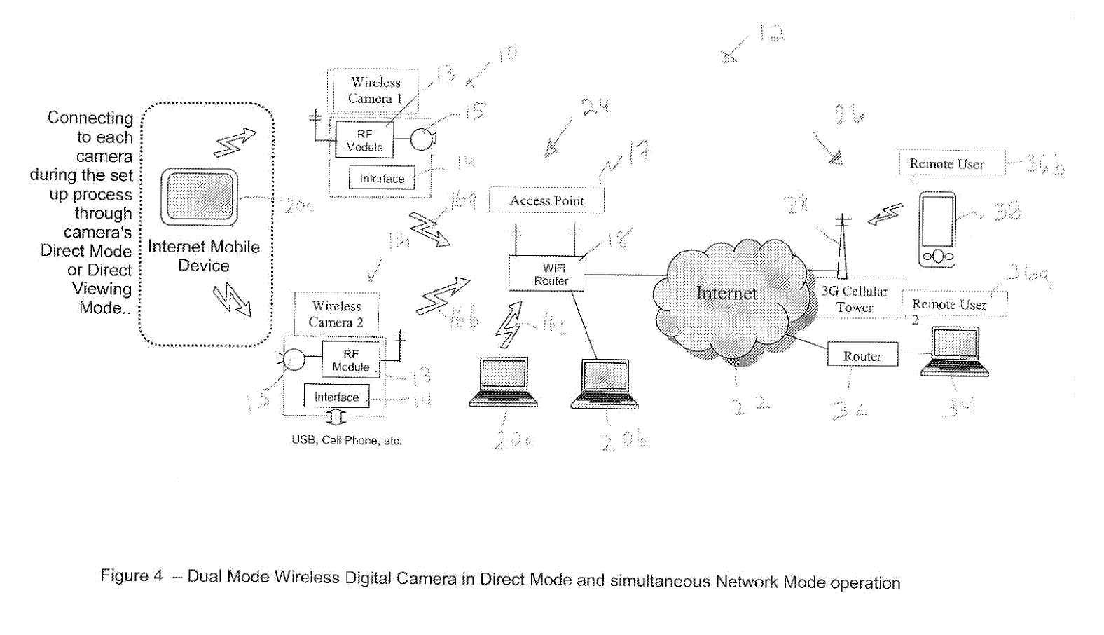

Preferably, each of the cameras 10 and 10a are operable in either of two modes or in a first direct mode and a second or network node. The second network mode is shown in FIG. 2 while the first or direct mode is shown in FIGS. 3-4. Preferably, a communication protocol is programmed and is embed in the RF module 13 of the wireless surveillance camera 10. The protocol enables the camera 10 equipped with the RF module 13 to interrogate an area. The RF module 13 preferably interrogates to find and identify a neighboring wireless device, for example, a laptop computer 20a, a laptop computer 20b or a mobile tablet device 20c or a mobile communication device (not shown) with similar RF module. Once found, the camera 10 or 10a and the second computing device 20a, 20b, 20c negotiate the procedures to establish a mutual connection.

In one non-limiting embodiment of the present disclosure, the camera 10 and 10a having the RF module 13 and controller (not shown) located in the interface 14 may modify a protocol stack in an existing RF module 13, 13a. In an alternative embodiment, the RF module 13 may comprise a RF chip that includes a Wi-Fi Direct® feature. Wi-Fi Direct® is incorporated by reference in its entirety, formerly known as Wi-Fi Peer-to-Peer®, is a set of software protocols that allow Wi-Fi devices to talk to each other without prior setup or the need for wireless access points (hot spots). Wi-Fi®Direct® allows the construction of ad-hoc networks between computers, or more commonly, computers and peripherals like printers. Wi-Fi®Direct® is developed and supported by the Wi-Fi®Alliance, the industry group that develops the Wi-Fi® CERTIFIED® standards suite.

Preferably, the camera 10 and 10a includes a software access point, or “soft AP”, into the camera 10 and 10a. When a device enters the range of the Wi-Fi Direct camera 10 and 10a, the processor located in the interface 14 preferably controls the RF module 13 to send a control signal to connect to the device by a predetermined protocol that is known to the at least two devices, for example, the camera 10 and the tablet device 20c. Thereafter, one of or both of the camera 10 and the tablet device 20c may exchange setup information using a Protected Setup-style transfer. Soft AP software is preferably stored on a memory on the interface 14 and may be sufficient to exchange video and audio digital data with optionally security settings to ensure that the data cannot be intercepted and inspected. In another embodiment of the present disclosure, the camera 10 and 10a may interrogate and link to the tablet 20c and the 20a and 20b via a access point that is not a Wi-Fi Direct® access point and various configurations are possible and within the scope of the present disclosure.

Advantageously, the present system 12 includes a simplified configuration for the user as the users operating the various computing devices 20a-20c and 34 and 38 can simply connect directly to the camera 10 and 10a to configure the camera's settings via a drop down menu that is readily available with any mobile device that is connected to the internet 22 or connected to the camera 10 and 10a. Preferably, the user is spared from connecting the wireless camera 10 and 10a via a router/access point. This procedure involves two connections and a discovery step between the camera 10 and 10a and the mobile device. Since this wireless connection 16, 16a, and 16b can be made wirelessly to the camera 10 and 10a without having to physically move the camera 10 and 10a or run cables the present system 12 is advantageous over the prior art configuration.

Preferably, once the RF module 13 and the computing device 20a-20c are linked then an RF channel connection is established from the RF module to the specific computing device 20a-20c. After the RF channel connection is established, the application software on the camera 10 and 10a stored on the memory and the application software stored on the memory (not shown) associated with the computing device 20a-20c preferably initiate an account authentication procedure automatically whereby the username and password of each of the devices 10-10a and computing devices 20a-20c is verified to ensure that only authorized access is permitted between each of the cameras 10-10a and the computing devices 20a-20c. In one non-limiting embodiment, preferably each wireless camera 10-10a has a credential information that is specific to the wireless camera 10-10a. The credential information may be set by an owner or an administrator that includes rights. The automatic authentication process blocks any unauthorized connection to the wireless camera 10-10a for video viewing to ensure that a secure connection and that only authorized personnel have access to the data.

Advantageously, the present system 12 does not require any existing network and the user may use the cameras 10 and 10a with any existing network and any existing computing devices 20a-20c. Additionally, the present cameras 10 and 10a also preferably serve as a wireless hotspot for the computing devices 20a-20c. In this regard, the computing devices 20a-20c preferably may receiving the digital data from the camera 10-10a to view the video and listen to the audio, but may also use the software access point located on the cameras 10 and 10a to access the internet 22 and transmit and receive data that is independent of the surveillance data. For example, at least one of the cameras 10, and 10a can support a 3G modem and provide internet connectivity over Wi-Fi to connected mobile devices 20a-20c whereas the computer 20a, 20b and 20c may transmit data to the camera 10, which communicates the data to the router 18 and to the internet 22. In this manner, the user may access an Internet browser on the computing device 20a-20c and view pages using the camera 10-10a as a mobile hotspot.

Turning to FIG. 3, there is shown a dual mode operation of the camera 10 and the camera 10a operatively connected to a tablet computer or internet mobile device 20c and a laptop computer 20a. In the direct mode of the camera 10, the camera 10 is directly connected to an Internet Mobile Device 20c, such as a mobile phone, a notebook computer, iPod® device, iPhone® or iPad® tablet device manufactured by Apple® Corporation, a net book computer, a BLACKBERRY® communication device manufactured by Research in Motion Corporation®, a MOTOROLA® DROID® communication device or a communication device operable with the HTC® GOOGLE® ANDRIOD® configuration, or another mobile communication device. Once connected, the user operating with the mobile device 20c may receive digital data from a video stream directly from the wireless camera device 10 via signal 16d.

Preferably using the tablet or internet mobile device 20 or the laptop computer 20a that camera 10 or 10a may be configured and settings adjusted. In this manner, the internet mobile device 20 or computer 20a acts as an input device for the camera 10 and 10a to configure one or more camera settings to perform certain desired functions. Settings may include instructing the camera 10 or 10a which wireless access point (AP) to connect with and the desired connection settings, or setting the network, setting one or more image parameters and setting one or more system 12 settings via connections 16b-16d as shown in FIG. 3.

The system 12 shown in FIG. 3, also provides that the internet mobile device 20c or the computer 20a may receive a signal from a camera 10 and 10a indicating a confirmation of access point network connection. In this manner, the user will also be able to use this direct connection to verify whether or not the camera connected properly to the access point (otherwise known as network mode) and whether the camera 10 and 10a or the device 20c or computer 20a have a proper connection to the Internet. In the event that there is no proper connection to the internet 22, then an appropriate signal will be output indicating that there is not a proper connection.

Preferably, the cameras 10 and 10a ease the set up of wireless digital camera in a network environment as shown as reference numeral 12. The user advantageously does not have to find and connect indirectly to the camera 10 and 10a through a traditional access point. System 12 also reduces the possible data transfer bottleneck due to the congestion from the traditional access point. Furthermore, unlike traditional network cameras, the system 12 can operate without having an available router or access point, which is advantageous and reduces costs.

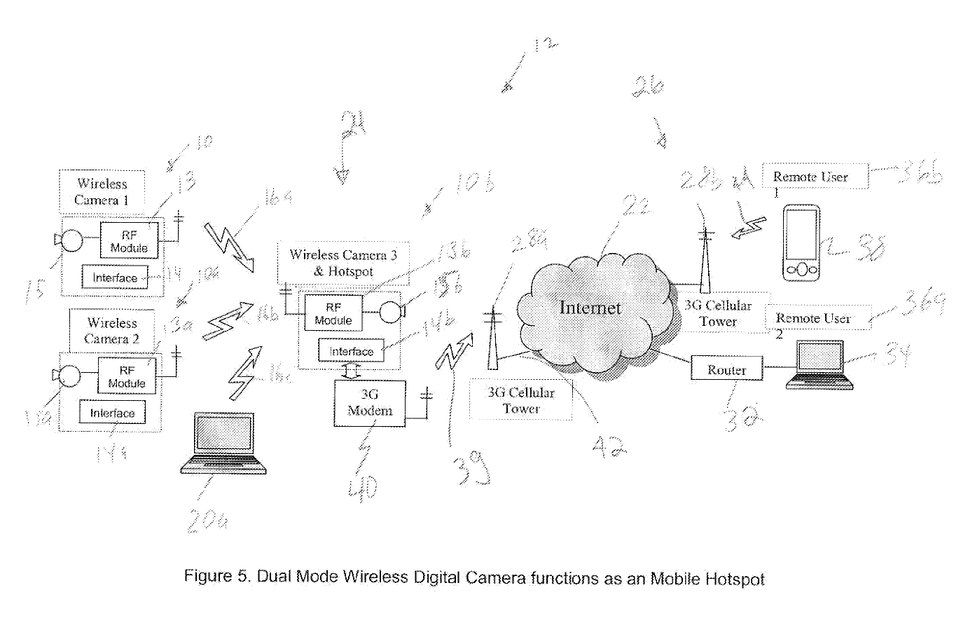

Turning now to FIG. 4, there is shown the dual mode wireless digital cameras 10a and 10 operating in a direct mode and a simultaneous network mode. As shown, the internet mobile device 20c may link to the camera's 10 and 10a access point generally shown as reference numeral 17. It should be appreciated that the access point 17 uses the RF module 14 and 14a to provide a connection to the internet mobile device 20c, computer 20a and computer 20b. The present disclosure preferably provides that at least one camera captures video and audio and also provides a wireless access point (WAP) to allow at least one wireless communication device or more to connect to a wireless network using Wi-Fi, Bluetooth or related standards. The WAP 17 formed by the at least one camera may connect to a router 18, dongle, 3G modem (28a in FIG. 5), or any other suitable device and to the internet 22 and can relay data between the wireless devices and wired devices on the network.

In this manner, the internet mobile device 20c may control one or more cameras 10 and 10a, view the video and audio output of the cameras 10 and 10a and also be connected to the internet 22 via the cameras 10 and 10a. Likewise, the mobile communication device 38 and computer 24 at the second location 26 may also view the output of the cameras 10 and 10a, control the video cameras 10 and 10a and access the data via a software platform at the second location 26.

The internet mobile device 20c can output a control signal wirelessly to control the surveillance camera 10 or 10a to pan, tilt, or zoom to the monitor the target from a remote location. Additionally, the internet mobile device 20c can output data to a software platform along a first path (from the access point 17 to the Wi-Fi router 18 and to the internet 22), a second path (from the access point 17 to the Wi-Fi router 18 and to the internet 22 and to the base station 28 to a mobile device 38) or a third path (from the access point 17 to the Wi-Fi router 18 and to the internet 22 to router 32 and to computer 34) to a remote destination 26.

In this manner, a remote user 36a and 26b can monitor the target and the data output from the cameras 10 and 10a from a remote location 26 in real time. Turning now to FIG. 5, there is shown a system 12 for capturing surveillance information of a target while also operating in a dual mode operating as a mobile hotspot for a computer device 20a.

The wireless camera 10b is shown as connecting to a computing device 20a, which can be a laptop as shown or an internet mobile device such as an iPad® tablet computer. Alternatively, the camera 10b can comprise a Wi-Fi dongle, 3G Modem or be connected to a 3G cellular phone. The wireless camera 10b can become an access point to allow other Wi-Fi enabled devices to connect to Internet and send/receive the data through the access point. In this manner, the wireless camera 10b becomes a mobile hotspot, which can set up and reconfigure the connected other wireless cameras shown as 10 and 10a. Preferably, the surveillance cameras 10-10b are connected to one another and linked via the access point and the connected wireless cameras 10-10b form an ad hoc group. In this manner, each of the wireless surveillance cameras 10-10b transmit the video data to a remote monitoring site such as SEEDONK® VIDEO MANAGEMENT sharing software platform for other desirable applications via the internet 22.

The paring of the access point formed by the camera 10b to remaining wireless cameras 10 and 10a may be accomplished via a set up initial procedure. In this manner, the desired camera 10, 10a can find the correct access point generated by the camera 10b and then connect to a 3G cellular dongle or modem 40 or other broadband service for Internet connection. This feature enables quick setup and installation of a remote video monitoring system without any prior cable wiring and broadband service set up to each and every camera 10, and 10b. Many applications can be easily implemented with minimum equipment costs and can be set up by an individual with minimal training.

In this embodiment of FIG. 5, a third camera 10b is provided that includes an RF module 13b, an image capture element 15b and an interface 14b. Interface 14b preferably is connected to a modem 40. In one embodiment, the modem 40 is a 3G modem that is operable with a wireless communication network, such as GSM, CDMA, WCDMA or the like (for example, modem 40 can be a Sprint® 3G/4G USB Modem U300). In another embodiment, the modem 40 may be a 4G modem. In a further embodiment, the modem 40 can be operable with Wi-Max or the like.

Various modem 40 configurations are possible and within the scope of the present disclosure and modem 40 is intended to be any modem 40 that connects to a wireless network and that attaches directly to a wireless ISP (Internet Service Provider) via base station 28a, which is connected to the internet 22. 3G refers to the International Mobile Telecommunications-2000 (IMT-2000) or the 3rd Generation standards for mobile telecommunications defined by the International Telecommunication Union. 3G preferably includes at least one of GSM, EDGE, UMTS, CDMA 2000 and WCDMA as well as Time Division Synchronous Code Division Multiple Access (“TD-SCDMA”), Digital Enhanced Cordless Telecommunications (“DECT”) and Wi-MAX®. 3G may further include a wide-area wireless voice telephone, video calls, and wireless data, all in a mobile environment that allows simultaneous use of speech and data services and higher data rates of up to about 14.0 Mbit/s on the downlink and about 5.8 Mbit/s on the uplink.

In this manner, the computer 20a may link via signal 16c with the camera 10b via an RF channel and RF module 15b and communicate with the modem 40 via the interface 40. In this manner, the computer 20a may be linked to the internet 22. Simultaneously, the system 12 may display the video and output audio data on the computer 20a or mobile communication device 38 and computer 34 at a remote location 14 along a number of communication paths.

In this embodiment, the system 12 is shown as having a first digital video camera 10, a second digital video camera 10a, a third digital video camera 10b and can have multiple other a digital video cameras. Each of the cameras 10-10b preferably includes a RF module 13, 13a, and 13b for transmitting signals and for receiving signals generally shown as reference numeral 16a-16c. The first through third digital video cameras 10-10b are connected to the computer 20a in a wireless manner via a Wi-Fi network created by the wireless access point formed by interface 14b, RF module 15b, and modem 40.

The first through third digital video cameras 10-10b are preferably cameras that take video or still photographs, or both, digitally by recording images via an electronic image sensor 15, 15a, and 15b. The first through third digital video cameras 10-10b may also include a night vision feature to record data and may include infrared light emitting diodes with auto activation and with a video resolution of about 640×480. The first through third digital video cameras 10-10b can be closed-circuit television cameras, generally used for security, surveillance, and/or monitoring purposes. The first through third digital video cameras 10-10b can be small, easily hidden, and able to operate unattended for monitoring a predetermined area for long periods of time. For example, the first through third digital video cameras 10-10b can be webcams operable for use as a closed circuit television camera and each may convert a signal from the electronic image sensor 15-15b directly to a digital output and can incorporate a circuit to directly interface with a specific protocol.

Alternatively, instead of the laptop computer 20a shown in FIG. 5, the first through third digital video cameras 10-10b can interface and output a digital signal to a different device. For example, the computer 20a may be Smart Phone, such as a BLACKBERRY® communication device or mobile phone, an APPLE® I-PHONE®, APPLE® I-POD® or IPAD®, a mobile phone, an e-Book Reader, or other device such as a computer or communications hardware, a net-book, a desktop, or a predetermined models of laptop computers. The first through third digital video cameras 10-10b may further communicate an output through an analog-to-digital converter in order to store the output or send the output to a wider network. The digital video may be H.261, H.263, H.264, JPEG, MJPEG, MPEG or any other digital video formats known in the art.

To output the video data from the camera 10 to the remote destination 26 and the computing devices 34 and 38, the data may take a first path from at least one of a number of digital video camera 10 to the camera 10b and then to the 3G modem 40, which communicates the data to a format suitable to the ISP shown as reference numeral 39 and to a 3G base station 28a, which is connected to the internet 22 via line 42. The personal computer 34 is operatively connected to a network router 32, which is connected to the Internet 22.

Another path continues from the Internet 22 to a wireless base station 28b, where the data is transmitted in a wireless manner along wireless signal 44 to a remote destination 26 and to a remote computing device or communication device 38. In this manner, the remote user 36b and remote user 36a may both view the output of the surveillance camera 10. In one aspect, the remote users 36a and 36b may access the data via a software program or platform that is installed at the computer 34 or the computer 38 or installed and run on the internet 22 in a cloud computing configuration.

The software platform preferably can be a SEEDONK® Video Management platform. The software platform can be a video monitoring and a video sharing application and is a consumer platform for viewing, managing and sharing cameras over the Internet 22. The computer 34 running the first software platform may be a cloud computing configuration or may include a memory, a processor, a bus, a display, a user interface, and network router 32 as shown in FIG. 5 generally as reference numeral 34. The computing devices 34 and 38 are merely illustrative. Devices 34 and 38 form no limitations to the present disclosure and are merely illustrative of one non-limiting embodiment. For example, using the software platform, the user 36a or 36b can be authenticated for access. Thereafter, the user 36a and 36b may then view the output of the digital video camera 10, 10a, 10b and video and audio data. The user 36a and 36b may then also use the prompts associated with the software platform to control the digital video camera 10-10b to pan, tilt, zoom or perform any other control functions associated with the digital cameras 10-10b and also send messages to other users.

Moreover simultaneously with the above transfer of data, computing device 20a, wireless camera 10 and 10a are not connected to the internet via a wired connection and instead are connected wirelessly via camera 10b. In this manner, camera 10 via the RF module 13 is transferring data to the internet 22 via the RF module 13b and modem 40. Further, the camera 10a via RF module 13a is transferring data to the internet 22 via the RF module 13b and modem 40. Further, computer 20a includes a transmitter and receiver and is communicating data via the RF module 13b and modem 40 to the internet 22.

In an alternative embodiment of the present disclosure, the modem 40 may be a 3G dongle 40. Dongle 40 is a broadband wireless adaptor or a connector that translates one type of port to another. 3G dongle 40 facilitates the transfer of digital data from one component of the system 12 to the base station 28a over a wireless telecommunication network. It should be appreciated that the transfer of digital data is achieved in packets over a specific predetermined frequency. Wireless telecommunications network is generally implemented with some type of remote information transmission system that uses electromagnetic waves, such as radio waves, for the carrier. The implementation usually takes place at the physical level or layer of the network.

Alternatively, in a further embodiment, the modem 40 may communicate with the remote destination 26 and the associated remote computing device 34 and 38 with a different standard, such as, for example, the IEEE 802.16 standard. Various configurations are possible and within the scope of the present disclosure. Thereafter, the data can be communicated to the remote destination 26 from the Internet 22 as previously discussed above or via a different manner such as for example, with a Network router, a Wi-Fi dongle, a Wi-Fi Router 34, Wi-Max, Cellular Phone Network via a base station 28b or a wireless protocol.

Preferably, the computer 20a, device 38, or computer 34 may control the specific digital camera 10-10b to initiate the display of the video data of the target, to magnify an image of the target, or to record the data or adjust any and all settings of one or more cameras 10-10b. Moreover, the computer 20a, device 38, or computer 34 may also send a control signal to specific digital camera 10, 10a, 10b to pan, tilt, and zoom.

A video processing operation may be performed on the data prior to sending the data from the first destination 24 to the second destination 26 or prior to sending the data from camera 10, 10a, and 10b to computer 20a. For example, data may be compressed prior to sending the data from the first destination 24 to the second destination 26. Frames may be removed from the images that are redundant prior to transmitting the data from the first destination 24 to the second destination 26. Various data rate configurations are possible and within the scope of the present disclosure. It should be appreciated that the video compression may even permit the transfer of video over a relatively small bandwidth. For example, each camera 10, 10a, and 10b may embed or incorporate data into the captured video image. The embed data can be text such as the day, hour, minute, second, camera identification information (Camera 1, Camera 2, etc.), alarm, object presence, event data, or any other identification data known in the art. Metadata may also be incorporated into the captured video image.

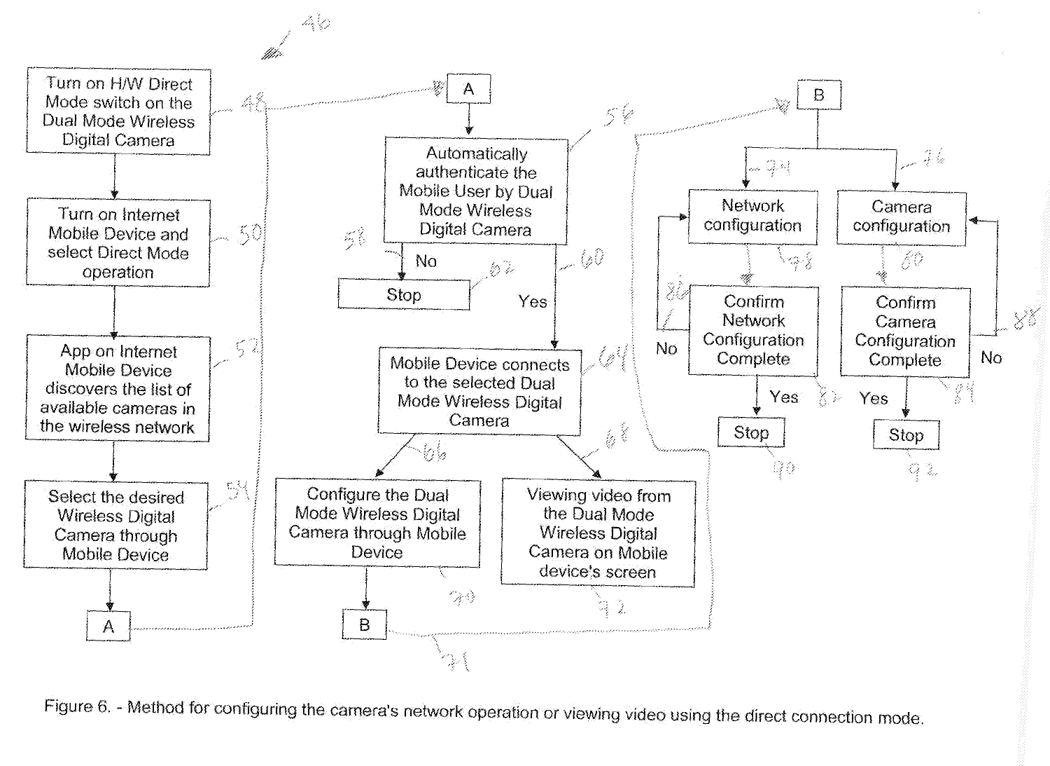

Turning now to FIG. 6, there is shown a method according to the present disclosure generally represented as reference numeral 46. The method 46 preferably is operable for configuring the camera network operation or viewing video using the direct connection mode. It should be also appreciated that the method steps are not limited to the hierarchal order shown and some steps can be performed before others and some steps can be performed simultaneously. Various configurations of the present method are possible and within the scope of the present disclosure.

The method 46 commences at step 48 whereby the direct mode switch, or direct mode input is selected on the dual mode wireless camera 10, 10a, 10b. The method then passes to step 50 where the internet mobile device computer 20a is activated and the direct mode operation input is selected thereafter control of the method 46 passes to step 52.

At step 52, a suitable software application is executed on the computing device 20a, which interrogates and determines which wireless cameras are in the interrogation zone and prompts the user with the available wireless cameras in the neighboring wireless networks. It should be appreciated that this can be one camera, two cameras, or any number of cameras depending on the size of the target area and availability. At step 54, a desired wireless digital camera is selected via an input on the internet mobile device computer 20a. Thereafter, control passes to step 56.

At step 56, a decision is reached as to whether the user is authenticated by the digital camera. If not authenticated, then control passes from step 56 along line 58 to step 62 where the method 46 ends as an unauthorized individual is seeking access.

If authenticated at step 56, then control of the method 46 passes from step 56 along line 60 to step 64 where the internet mobile device computer 20a is connected to the dual mode wireless digital camera 10 and at step 72, the user may view video output from the desired camera 10 on the mobile internet device screen. Additionally, if authenticated at step 56 and if the mobile device 20a connects to the desired digital camera at step 64, then the camera can be configured via the mobile computing device 20a at step 70.

Thereafter, control of the method 46 passes from step 70 along line 71 to line 74 to step 78 where a network configuration is performed. Also control of the method 46 passes from step 70 along line 71 to line 76 to step 80 where a camera configuration step occurs. For example, the desired camera can be configured from the mobile device 20a by entering the wireless access point connection information. Thereafter, control passes from step 78 to step 82 where a decision is reached as to whether the network configuration process is complete. If complete then the method 46 ends at step 90. If not complete, then the method 46 continues along line 86 to step 78.

Thereafter, control of the method 46 passes from step 80 to step 84 where a decision is reached as to whether the camera configuration process is complete. If complete then the method 46 ends at step 92. If not complete then the method 46 continues along line 88 to step 80 to continue the camera configuration process.

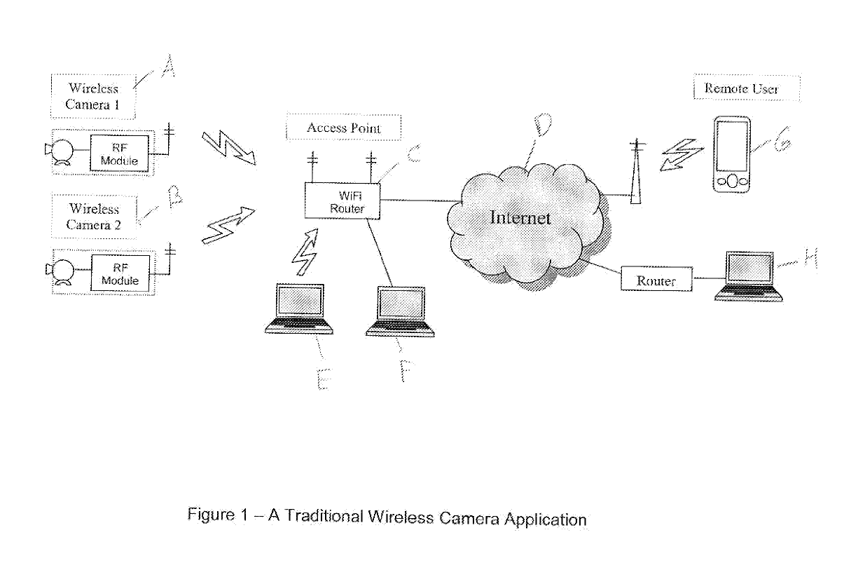

Generally, in operation, the computer system operable with that method shown in FIGS. 1-6 is controlled by an operating system. Typical examples of operating systems are MS-DOS, Windows95, 98, 2000, XP, Vista and Windows 7 from Microsoft Corporation, or Solaris and SunOS from Sun Microsystems, Inc., UNIX based operating systems, LINUX based operating systems, or the Apple OSX from Apple Corporation. As the computer system operates, input such as input search data, database record data, programs and commands, received from users or other processing systems, are stored on storage device. Certain commands cause the processor to retrieve and execute the stored programs. The programs executing on the processor may obtain more data from the same or a different input device, such as a network connection. The programs may also access data in a database for example, and commands and other input data may cause the processor to index, search and perform other operations on the database in relation to other input data. Data may be generated which is sent to the output device for display to the user or for transmission to another computer system or device. Typical examples of the computer system are personal computers and workstations, hand-held computers, dedicated computers designed for a specific purpose, and large main frame computers suited for use many users. The present invention is not limited to being implemented on any specific type of computer system or data processing device.

It is noted that the present invention may also be implemented in hardware or circuitry which embodies the logic and processing disclosed herein, or alternatively, the present invention may be implemented in software in the form of a computer program stored on a computer readable medium such as a storage device. In the later case, the present invention in the form of computer program logic and executable instructions is read and executed by the processor and instructs the computer system to perform the functionality disclosed as the invention herein. If the present invention is embodied as a computer program, the computer program logic is not limited to being implemented in any specific programming language. For example, commonly used programming languages such as C, C++, JAVA as well as others may be used to implement the logic and functionality of the present invention. Furthermore, the subject matter of the present invention is not limited to currently existing computer processing devices or programming languages, but rather, is meant to be able to be implemented in many different types of environments in both hardware and software.

Furthermore, combinations of embodiments of the invention may be divided into specific functions and implemented on different individual computer processing devices and systems which may be interconnected to communicate and interact with each other. Dividing up the functionality of the invention between several different computers is meant to be covered within the scope of the invention.

While this invention has been particularly shown and described with references to a preferred embodiment thereof, it will be understood by those skilled in the art that is made therein without departing from the spirit and scope of the invention as defined by the following claims.

What is claimed is:

1. A method comprising:
capturing data comprising at least one of video and audio from a camera comprising a transmitter and receiver integrated with the camera, wherein the camera further provides a wireless access point to allow access to a network.

2. The method of claim 1, further comprising wirelessly transmitting the data to a portable device to output the data for inspection on the portable device;
the camera with the transmitter and the receiver transmitting the data to a second destination to output the data at the second destination; and
wherein the camera interrogates a plurality of devices to link to the plurality of devices, and wherein once linked the camera transmits the data to the plurality of devices to output the data on the plurality of devices, or provides the wireless access point to allow the plurality of devices to access the network.

3. The method of claim 2, further comprising transmitting the data to an internet mobile device.

4. The method of claim 2, further comprising transmitting the data to a computing device.

5. The method of claim 2, further comprising transmitting the data to the second destination by at least one of a plurality of communication paths to the second destination.

6. The method of claim 5, further comprising transmitting the data to the second destination by a router connected to the internet.

7. The method of claim 2, further comprising transmitting the data to the second destination by a computing device connected to a router that is connected to the Internet.

8. The method of claim 2, further comprising transmitting the data to the second destination by the computing device connected to the network router that is connected to the Internet, and communicating the data to a second network router to a second computing device.

9. The method of claim 2, further comprising communicating the data to a base station and to a second portable device for viewing the data comprising video and listening to the data comprising audio on the second portable device.

10. The method of claim 2, further comprising communicating the data to a router and to the Internet and to at least one of (i) a base station, or (ii) a router and to a (i) mobile device or (ii) a computing device located at the second destination.

11. The method of claim 2, wherein the data is captured by a second camera comprising an RF module, an image capture element, and an interface, the data being transmitted by the RF module to the camera that forms the access point and further communicating the data from the access point to a router connected to the Internet, wherein the data is communicated to the second destination.

12. The method of claim 2, wherein the data is captured by a second camera comprising an RF module, an image capture element, and an interface, the data being transmitted by the RF module to the camera that forms the access point and further communicating the data from the access point to (i) a dongle, or (ii) a wireless modem connected to a base station, which is connected to the Internet, wherein the data is communicated to the second destination.

13. The method of claim 2, further comprising selecting the communication path to transmit the data to the second destination from the plurality of communication paths.

14. The method of claim 13, further comprising selecting from transmitting the data from at least two communication paths to the second destination.

15. The method of claim 2, further comprising controlling the camera from a signal from the portable device.

16. The method of claim 2, further comprising controlling the camera from a signal from the second destination.

17. The method of claim 2, further comprising recording the data at the portable device, the second destination, the internet, the camera or a device connected to the access point.

18. The method of claim 2, further comprising at least two cameras, wherein at least two cameras are adapted to capture video and audio data and at least one camera provides the wireless access point to allow at least the other camera to be connected to the wireless access point and the network, and to allow the portable computing device to be connected to the wireless access point and the network.

19. A wireless camera comprising:
an image capture device for capturing video images;
a transmitter;
a receiver; and
a circuit that provides a wireless access point to allow access to a wireless network by at least a second device.

20. The camera of claim 19, further comprising a microphone and wherein the camera captures video and audio and transmits the video and audio via the transmitter.

21. The camera of claim 20, further comprising a plurality of cameras with each capturing video and audio and each of the plurality of surveillance cameras comprising a transmitter and a receiver, wherein at least one of the cameras provides the wireless access point to allow at least the remaining cameras access to the network.

22. The camera of claim 19, wherein the camera is a pan, tilt, zoom camera.

23. The camera of claim 19, wherein the camera captures video and audio, and wherein the camera transmits the video and audio in a digital signal.

24. The camera of claim 19, further comprising a memory for recording the data.

25. The camera of claim 19, wherein the wireless access point is wirelessly connected to at least one of (i) a router that is connected to the internet, (ii) a wireless modem that is connected to the internet, or (iii) a second camera wirelessly connected to the internet.

26. The camera of claim 19, wherein the second device is a mobile communication device that is connected to the wireless access point, and wherein video and audio data captured by the camera is output for display on the mobile communication device, and wherein the mobile communication device is wirelessly connected to the wireless access point, and the wireless access point is wirelessly connected to a network router to the Internet.

27. The camera of claim 19, wherein the transmitter and receiver are located in an RF module integrated therein.

28. The camera of claim 19, further comprising a wireless router being connected to the wireless access point, the wireless router being connected to the internet and to at least a second computing device.

29. The camera of claim 28, wherein the second computing device receives data from the camera for display on the second computing device.

30. The camera of claim 29, wherein the second computing device controls at least one parameter of the camera.

31. The camera of claim 30, wherein the second computing device comprises at least one of a personal computer or a mobile communication device.

32. The camera of claim 31, wherein the second computing device records video and audio.

33. The camera of claim 32, wherein the second computing device receives data from a wireless modem.

34. The camera of claim 19, further comprising a rechargeable power source operatively coupled to camera, and wherein the camera is mobile.

35. The camera of claim 19, further comprising a second wireless camera comprising a second image capture device for capturing video images, and a second transmitter and a second receiver, wherein the second image capture device captures video data, and wherein the second transmitter transmits the data to the wireless access point, and wherein the camera communicates the data to a second destination.

36. A surveillance camera comprising:
an image capture device for capturing digital video images, and a microphone for capturing audio data; and
an RF unit comprising a transmitter and a receiver that is connected to the image capture device and microphone, the RF unit communicating with a router for directing the captured video images and audio data to (i) a portable device and to (ii) a computing device associated with a remote destination via at least one communication path of a plurality of communication paths, wherein the surveillance camera further provides a wireless access point to allow access to a network by at least one of (i) a second camera, (ii) a computing device, and (iii) a mobile communication device.

37. The surveillance camera of claim 36, wherein the mobile communication device, the computing device or a different device is operable to control the image capture device, and the RF unit.

38. A method comprising:
capturing data comprising digital video images and audio data; and
routing the captured video images and audio data to (i) a router at a first mobile location and (ii) a second computing device at a second remote destination, wherein the data is captured by a device that further provides a wireless access point to allow access to a network.

39. The method of claim 38, further comprising routing the captured video images and the audio data along at least one of a first communication path, a second communication path or a third communication path;
the first communication path being from the network router to a personal computing device;
the second communication path being from the device to a wireless router to the Internet and to the second remote destination;
the third communication path being from the device to a base station and to the second remote destination; and
wherein at to the second remote destination the second computing device receives the data from the Internet.

40. A device comprising:
a receiver for receiving data associated with captured video images and audio data; and
a transmitter to transmit data to a computing device associated with a remote destination via at least one communication path of a plurality of communication paths, wherein the transmitter and the receiver are integrated into a surveillance camera, wherein the surveillance camera further provides a wireless access point to allow a second device access to a wireless network.

41. The device of claim 40, wherein the surveillance camera uses the transmitter and receiver to continuously interrogate a predetermined area over a predetermined time period to locate a plurality of second devices and provide the second devices access to the wireless network.
